(19) United States
(12) Patent Application Publication
(10) Pub. No.: US 2010/0059641 A1
(43) Pub. Date: Mar. 11, 2010

(54) Mounting Systems for Photovoltaic Modules

(75) Inventors: Edward N. Twesme, New Hope, PA (US); Salvatore G. Staiano, Flemington, NJ (US); Ding Yu, Princeton, NJ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: EPV Solar, Inc., Robbinsville, NJ (US)

(21) Appl. No.: 12/557,389

(22) Filed: Sep. 10, 2009

Related U.S. Application Data
(60) Provisional application No. 61/136,507, filed on Sep. 10, 2008.

(51) Int. Cl. A47B 96/06; F16B 47/00

(52) U.S. Cl. 248/205.3; 248/309.1; 248/316.7; 248/205.1

(57) ABSTRACT

The present invention provides apparatuses for photovoltaic modules, including frameless photovoltaic modules, to structural supports, such as various architectural elements. In addition, the present invention provides methods of mounting photovoltaic modules using the various apparatuses.

### CROSS REFERENCE TO RELATED APPLICATIONS

The present application claims the benefit of U.S. Provisional Patent Application No. 61/136,507, filed Sep. 10, 2008, the disclosure of which is incorporated by reference herein in its entirety.

### BACKGROUND OF THE INVENTION

1. Field of the Invention

The present invention relates to mounting systems for photovoltaic modules, including frameless photovoltaic modules and methods of mounting photovoltaic modules.

2. Background of the Invention

Thin film solar cells are typically constructed of a semiconductor-containing film, such as amorphous silicon, on a substrate. The substrate of the solar cell can be made of glass or a metal, such as aluminum, niobium, titanium, chromium, iron, bismuth, antimony or steel. Soda-lime glass is often used as a substrate because it is inexpensive, durable and transparent. Amorphous silicon solar cells are often prepared as frameless (i.e., without a metal frame or other supporting external structure) panels. The large size of the modules and their weight makes them difficult to handle and mount. In addition, their large surface area makes them susceptible to environmental loads, such as wind, snow, rain, ice, etc. It is necessary to mount these photovoltaic modules such that they are fully supported and able to withstand the required loads.

Current methods of mounting frameless photovoltaic modules rely on the attachment of channels or brackets that serve as attachment points to structural supports. These brackets are typically attached at strategic points on the back of the photovoltaic module to maximize load carrying capability of the module. The brackets are designed so that the hexagonal head of a ¼ inch machine screw, or like fasteners, will slide into a channel in the bracket and hold the module securely in place when a matching nut is applied to affix the module to the mounting structure. While such an assembly securely holds the modules in place and readily passes the load testing requirements, the process of mounting modules with the mounting brackets/screw-bolt assembly is a labor intensive process. Careful alignment of the bolt head in the bracket channel is required and maintaining the bolt in the proper location and aligning it with mounting holes in the structure requires installation personnel both above and below the module during this procedure.

Other currently available mounting systems for frameless modules rely on clamps or clips that hold the module at the edge. The edge of the module is the area most susceptible to stresses when subjected to loading, and the location at the edge subjects the entire module to the maximum stress under a given load. Modules mounted in this manner have significantly reduced load carrying capability under the influences of wind, snow and ice compared to more centrally located mountings.

### BRIEF SUMMARY OF THE INVENTION

What is needed therefore is a system for mounting photovoltaic modules, including frameless photovoltaic modules, that provide excellent load carrying support while also allowing for mounting of the modules from the top side of the support structure. The present invention fulfills these needs.

In exemplary embodiments, the present invention provides mounting apparatuses for a photovoltaic modules. Suitably, the apparatuses comprise a first surface having an interface for attachment to the photovoltaic module. A first support leg is coupled to and extends from the first surface opposite the interface. The apparatuses further comprise a first support element coupled to and extending from the first support leg and oriented substantially parallel to the first surface. A second support leg is coupled to and extends from the first surface opposite the interface. The apparatuses also comprise a second support element coupled to and extending from the second support leg and oriented substantially parallel to the first surface. Suitably, the first support element and the second support element form a channel. Suitably, the apparatuses of the present invention are used to mount frameless photovoltaic module.

In exemplary embodiments, the interfaces comprise one or more spacers, and suitably an adhesive. The second support leg suitably extends beyond the first support leg. In exemplary embodiments, the first support leg is formed integral with the first surface, the first support element is formed integral with the first support leg, the second support leg is formed integral with the first surface, and the second support element is formed integral with the second support leg.

Suitably, the first support element is not attached to the second support element or the second support leg. In further embodiments, the first support element, the second support leg and the second support element form a channel.

In embodiments, interface of the first surface is between about 0.1 to about 6 inches by about 0.7 to about 14 inches in dimension, Suitably, the first leg is between about 0.01 to about 2 inches in length. the second leg is between about 0.02 to about 12 inches in length, the first support element is between about 0.1 to about 4 inches by about 0.7 to about 14 inches in dimension, and the second support element is between about 0.1 to about 6 inches by about 0.7 to about 14 inches in dimension. The first and/or second support elements can further comprise a cushion pad, and/or a module shim clip can be included within the channel. In exemplary embodiments, the apparatuses comprise metal (e.g., aluminum or steel) or a polymer.

The present invention also provides supported photovoltaic module, comprising a structural support and a photovoltaic module mounted to the structural support via a mounting apparatus of the present invention.

In further embodiments, the present invention provides methods of mounting a photovoltaic module to a structural support. The methods suitably comprise providing a photovoltaic module comprising at least one mounting apparatus of the present invention attached to the photovoltaic module via an interface of a first surface of the apparatus. The photovoltaic module is then mounted to the structural support by contacting at least the first support element to the structural support. In exemplary embodiments, the mounting methods can comprise providing a photovoltaic module, attaching at least one mounting apparatus of the present invention to the photovoltaic module via an interface of a first surface of the apparatus, and mounting the photovoltaic module to the structural support by contacting at least the first support element to the structural support.

The present invention further provides methods of mounting a photovoltaic module to at least two structural supports. Suitably, such mounting methods comprise providing a photovoltaic module comprising at least a first and a second mounting apparatuses (suitably 4 or 6 or more) of the present invention attached to the photovoltaic module via an interface of a first surface of the apparatuses. In exemplary embodiments, a photovoltaic module is provided, and then at least a first and a second mounting apparatuses of the present invention are attached to the photovoltaic module via an interface of a first surface of the apparatuses. The photovoltaic module is then mounted to the structural supports by contacting the first support element of the first mounting apparatus to the first structural support and then the first support element of the second mounting apparatus to the second structural support.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1A and 1B show a mounting apparatus for a photovoltaic module in accordance with one embodiment of the present invention.

FIG. 1 C shows a module shim clip in accordance with an embodiment of the present invention.

FIG. 2 shows mounting apparatuses of the present invention securing a photovoltaic module to a structural support in accordance with an embodiment of the present invention.

FIG. 3 shows an additional mounting apparatus for a photovoltaic module in accordance with an embodiment of the present invention.

FIGS. 4A-4C show mounting apparatuses of the present invention securing a photovoltaic module to a structural support in accordance with additional embodiments of the present invention.

FIG. 5 shows a mounting apparatus of the present invention securing a photovoltaic module to a structural support in accordance with additional embodiments of the present invention.

The present invention will now be described with reference to the accompanying drawings. In the drawings, like reference numbers indicate identical or functionally similar elements.

### DETAILED DESCRIPTION OF THE INVENTION

It should be appreciated that the particular implementations shown and described herein are examples of the invention and are not intended to otherwise limit the scope of the present invention in any way. Indeed, for the sake of brevity, conventional manufacturing and photovoltaic cell production may not be described in detail herein.

The present invention provides mounting apparatuses and systems for mounting photovoltaic modules, suitably frameless photovoltaic modules. The present invention also provides supported photovoltaic modules and methods of mounting photovoltaic modules, suitably frameless photovoltaic modules.

It should be understood that the spatial descriptions (e.g., “above”, “below”, “up”, “down”, “top”, “bottom”, etc.) made herein are for purposes of illustration only, and that apparatuses and systems of the present invention can be spatially arranged in any orientation or manner.

The term “about” as used herein in relation to a value is used to mean±10% of that value, and values within that range. For example, “about 10 inches” encompasses values between 9-11 inches.

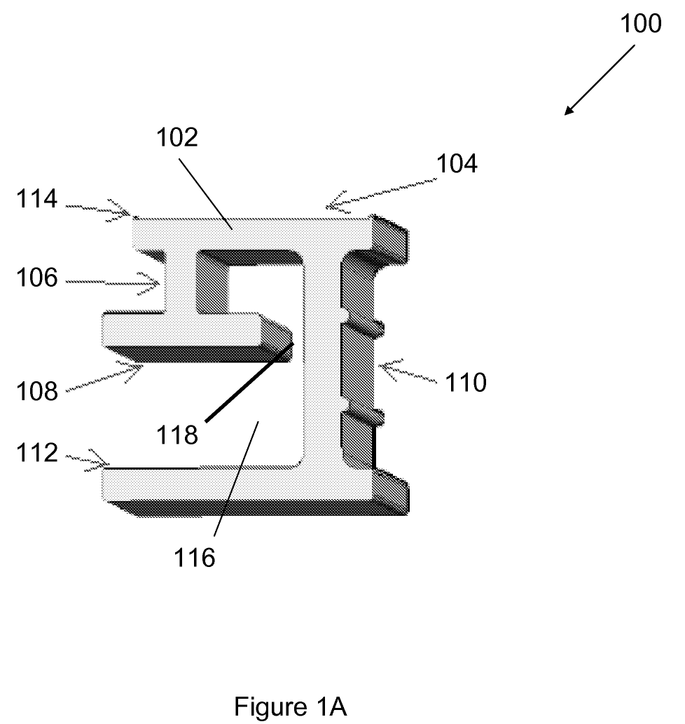

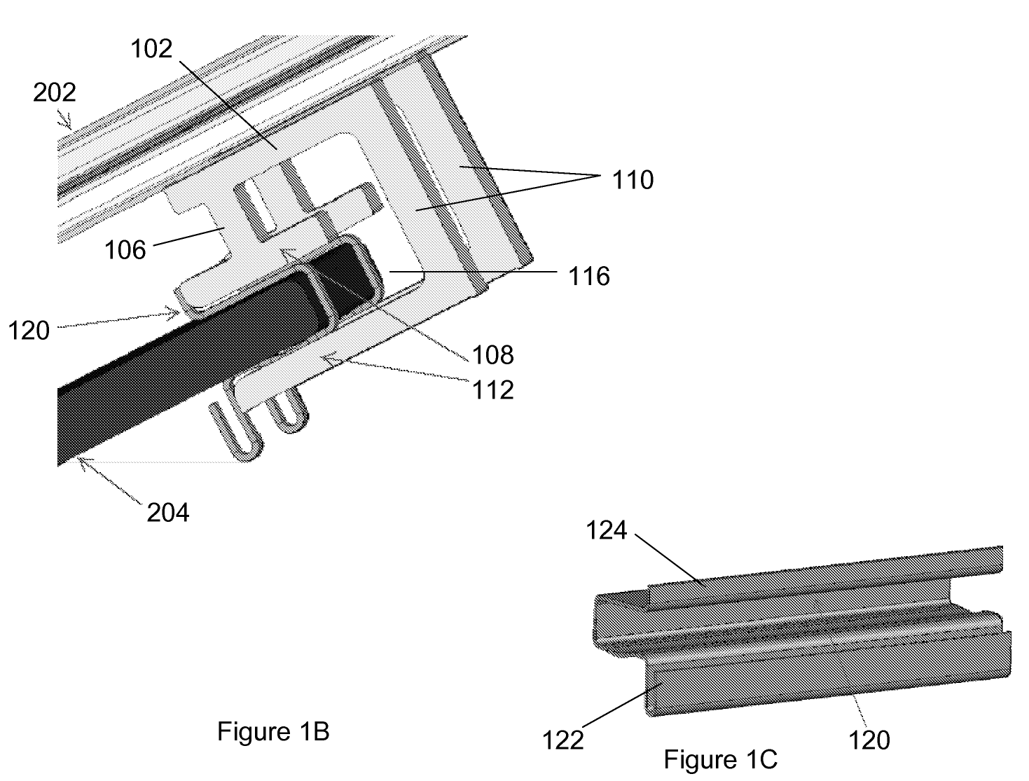

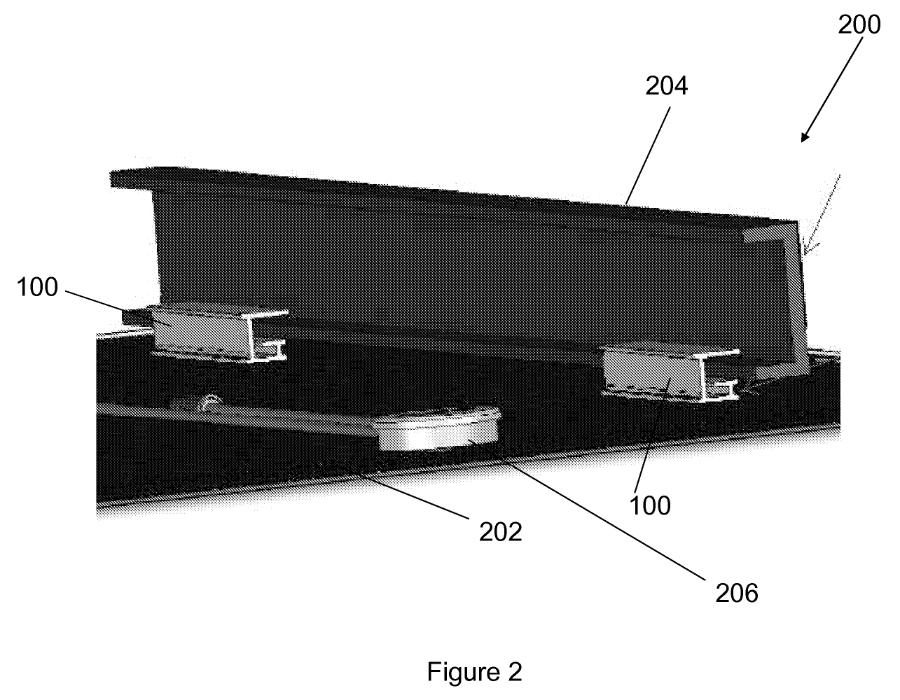

In one embodiment, as shown in FIG. 1A, the present invention provides a mounting apparatus(es) 100 for a photovoltaic module. The apparatus suitably comprises a first surface 102 having an interface 104. The interface 104 allows for attachment to a photovoltaic module 202 (see FIG. 2).

As shown in FIG. 1A, apparatus 100 also comprises at least a first support leg 106. This first support leg 106 suitably couples to and extends from the first surface 102 at a position opposite interface 104. As used herein “opposite” is used to indicate that in suitable embodiments, first support leg 106 extends from first surface 102 at a position that is on the opposing side of the first surface 102 as interface 104. As shown in FIG. 1A, first support leg 106 is suitably positioned so that it is perpendicular to interface 104 of first surface 102. However, first support leg 106 can be positioned at any angle, and in addition, can be positioned at other orientations relative to interface 104, for example, first support leg 106 can be positioned alongside or next to interface 104. As used herein “coupled to” includes embodiments in which the elements are attached (e.g., via adhesive, screw, bolt, solder, weld or other attachment mechanism) or are simply formed of the same material (“formed integral with”). As used herein, “extending from” includes embodiments in which elements are simply prepared from the same material (e.g., molded or formed, and thus “formed integral with”) and also includes attaching the various elements by bonding or contacting two surfaces to each other, such as by using various adhesives, screws, bolts, nails, rivets, solder, welds, etc.

Apparatus 100 further comprises a first support element 108 coupled to and extending from first support leg 106. Suitably, first support element 108 is oriented substantially parallel to first surface 102 (and interface 104). In suitable embodiments, first support element 108 and first support leg 106 are prepared from the same piece of material (as suitably are all elements of apparatus 100) such that they are simply formed together (e.g., molded, formed, rolled, cast, milled, etc.) from the same substance. As used herein, the phrase “substantially parallel” as it refers to the orientation of first 108 and/or second 112 support elements and first surface 102, means that the largest surface area (e.g., the surface area that will contact the support structure) of the first 108 and/or second 112 support elements is oriented so that it lies in the same plane as first surface 102 (and therefore interface 104), or within about 0° to about 45° of the same plane as first surface 102 (and therefore interface 104).

As shown in FIG. 1A, suitably apparatus 100 also comprises a second support leg 110 coupled to and extending from the first surface 102 opposite interface 104. Second support leg 110 suitably comprises a second support element 112 that is coupled to extends therefrom and that is oriented substantially parallel to first surface 102. Suitably, first support element 108 and second support element 112, in addition to being substantially parallel to first surface 102 (and interface 104), are also substantially parallel to each other. As shown in FIG. 1, a channel 116 is formed between the bottom surface of first support element 108, and the top of second support element 112. As shown in FIG. 1A, suitably second support leg 110 extends beyond first support leg 106 to form the channel 116. It is within this channel that a structural support 204 is suitably oriented (see FIG. 2).

While the mounting apparatus, mounting systems and mounting methods of the present invention can be utilized for any photovoltaic modules, suitably, the apparatus, systems, and methods are utilized with frameless photovoltaic modules. Generally, frameless photovoltaic modules comprise a photovoltaic cell (or a plurality of cells) positioned between two support substrates, for example, glass plates. The glass plates are not surrounded by a metal (or other material) frame as is typically found in crystalline (e.g., crystalline Si) solar modules. In general, mounting generally occurs by attaching brackets or supports to the frames of these modules. As described herein, mounting frameless modules has traditionally required the use of brackets that were screwed onto support elements, or via clamps or other edge-mounted supports. However, the use of screw-down brackets is very time consuming and cumbersome, and edge mounting often does not provide the required stability. The apparatus, systems and methods of the present invention, however, allow for improved ease of mounting (e.g., only one technician above or below the modules may be needed), but maintain the required increased stability and load support. In particular, the mounting apparatus of the present invention is useful for facile and stable mounting of “large area” photovoltaic modules (e.g., photovoltaic modules having an active area of about 0.5 m² or more, or about 0.75 m² or more, or about 1 m² or more).

As shown in FIG. 1A, interface 104 suitably comprises one or more spacers 114. Spacers 114 are suitably made from the same material as interface 104 (and therefore first surface 102) and provide a mechanism by which interface 104 can be separated from the surface of a photovoltaic (PV) module to which apparatus 100 is to be attached. In exemplary embodiments, interface 104 has an “S-shaped” double channel formed on it.

Suitably, interface 114 comprises an adhesive that is used to bond or adhere apparatus 100 to the PV module 202 (see FIG. 1B). The use of spacers 114 allows for this adhesive to spread across the surface of interface 104, but not leak out and become too thin of a coating when pressed against the surface of the PV module 202. Maintaining some separation between interface 104 and the surface of the PV module allows for a sufficient amount of adhesive to contact both the interface 104 and the PV module, thereby providing a sufficient bond or attachment to keep them together. Exemplary adhesives that can be used in the practice of the present invention include, but are not limited to structural adhesives, for example, silicone- or urethane-based adhesives, such as those available from Dow Corning®, Midland, Mich., including 99S X4-4647, and X4-4643 Silicon Structural Adhesives.

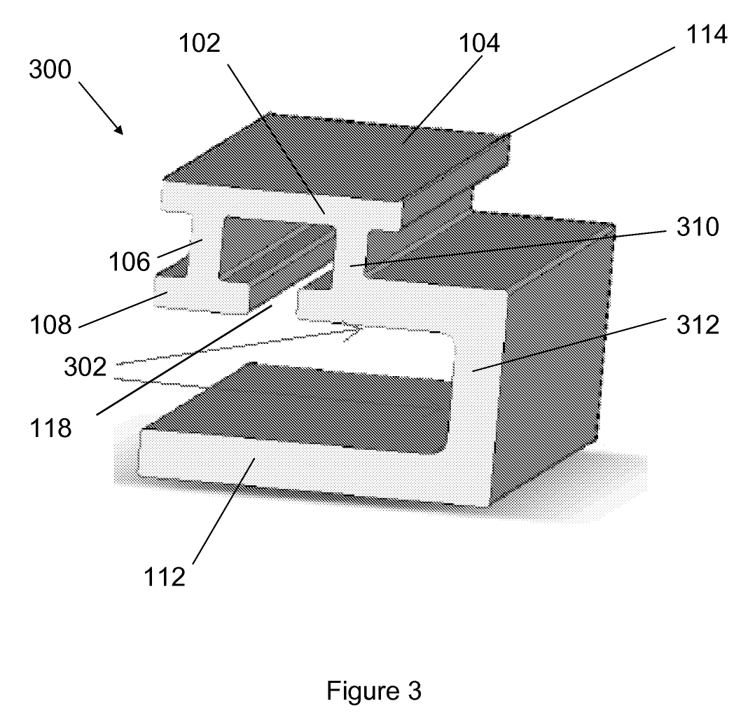

In an exemplary embodiment, first support element 108 is not attached to second support element 112 or second support leg 110 (see 118 in FIGS. 1 and 3). By maintaining separation between first support element 108 and both second support leg 110 and second support element 112, the first support element 108 and second support element 112 are able to flex and bend independent of one another. This allows for easier mounting during installation, as well as increased flexibility and bending during exposure of the photovoltaic module to external stresses or loads in the field. It should be noted, in other embodiments however, first support element 108 can be in contact with second support leg 110, or a second support leg can be eliminated, and both first and second support elements can extend from the same support leg.

In exemplary embodiments, interface 104 of first surface 102 has dimensions (i.e., the surface of interface 104) of between about 0.1 to about 6 inches by about 0.7 to about 14 inches. Suitably, interface 104 has dimensions of about 1 to about 6 inches by about 2 to about 14 inches, or about 2 to about 6 inches by about 5 to about 14 inches. First support leg 106 suitably is between about 0.01 to about 2 inches in length, for example, about 0.1 to about 2 inches in length, or about 0.2 and about 0.7 inches in length. Suitably, second support leg 110 is between about 0.02 to about 12 inches in length, for example, about 0.1 to about 12 inches, about 0.1 to about 5 inches, or about 0.3 to about 1 inches.

First support element 108 suitably has dimensions (i.e., the surface of first support element 108) of between about 0.1 to about 6 inches by about 0.7 to about 14 inches, for example, about 0.1 to about 6 inches, by about 3 to about 10 inches, about 0.1 to about 6 inches, by about 4 to about 8 inches, about 0.2 to about 1 inches, by about 4 to about 8 inches, about 0.5 to about 1 inches, by about 4 to about 8 inches, suitably about 0.75 inches by about 6 inches.

Second support element 112 (i.e., the surface of second support element 112) suitably has dimensions of between about 0.1 to about 6 inches by 0.02 to about 12 inches, for example, about 0.2 to about 4 inches by about 0.1 to about 14 inches, about 0.2 to about 4 inches by about 0.1 to about 10 inches, about 0.2 to about 1.4 inches by about 0.1 to about 5 inches, or about 0.2 to about 0.7 inches by about 0.1 to about 1 inches.

In exemplary embodiments, apparatus 100 of the present invention has dimensions where first support leg 106 is about 0.4 inches long, second support leg 110 is about 0.8 inches long so as to provide a space between first and second support elements (i.e., the “height” of channel 116) of about 0.26 inches. Suitably, first support element is about 0.5 inches wide and second support element is about 0.85 inches wide.

In further embodiments, apparatus 300 of the present invention has dimensions where first support leg 106 is about 0.4 inches long, second support leg 110 is about 0.8 inches long so as to provide a space between first and second support elements (e.g., the “height” of channel 116) of about 0.26 inches. Suitably, first support element is about 0.5 inches wide and second support element is about 1.1 inches wide.

In exemplary embodiments, the first 108 and/or second support elements 112 can optionally comprise a cushion pad on their surface. This cushion pad can line the entire area of channel 116, or can simply be on the surface of the two support elements (e.g., the bottom of first support element 108 and the top of second support element 112). In additional embodiments, as shown in FIG. 1B, the channel 116 can further comprise a module shim clip 120. FIG. 1B shows two sets of apparatus 100 that are interfaced with structural support 204. It should be noted that cushion pads and shim clip 120 can also be used with other apparatus of the present invention, including apparatus 300.

In exemplary embodiments, module shim clip 120 comprises a spring-loaded clip, a plastically deformable material, or an elastically deformable material and the like. Suitably, module shim clip 120 comprises a metal, a plastic (e.g., a polymer), or other suitable materials. Module shim clip 120 can facilitate attachment of the apparatus to a structural support, and can have, for example, a laminar shape, a coiled shape, or any three-dimensional shape suitable for occupying channel 116 and fitting onto a support structure. An exemplary shape of module shim clip 120 is shown in FIG. 1C. As shown in FIG. 1C, module shim clip 120 can suitably comprise edges 122 and 124 that are bent so as to maintain the clip at the opening of channel 116 (and thus prevent insertion of structural support 204 beyond a desired point) and also aid in insertion of the clip 120 into the channel 116. Module shim clip 120 helps to lock in place and limit the movement of module 202 when mounted to a structural support.

In exemplary embodiments, module shim clip 120 comprises a metallic material (e.g., aluminum, steel, etc.) and has thickness of about 0.01 to about 0.25 inches, or about 0.2 inches. Module shim clip 120 suitably has an opening that is about 0.01 to about 6 inches, or about 0.1 to about 0.5 inches, suitably about 0.2 inches. The depth (i.e., channel depth) of module shim clip 120 is suitably about 0.1 to about 5 inches, or about 0.1 to about 1 inches, or about 0.1 to about 0.5 inches, suitably about 0.28 inches. The overall length of module shim clip 120 is suitably about 0.5 to about 14 inches, or about 2 to about 6 inches, suitably about 2 inches. Edges 122 and 124 are suitably on the order of about 0.1 to about 1 inch in length, suitably about 0.2 inches in length. In general, the width of module shim clip 120 is the same as the width of apparatus 100 or 300 (and thus, the width of channel 116 or 302).

Suitably, the mounting apparatus of the present invention is a formed, machined or extruded material. That is, the apparatus is prepared from a single piece of material and shaped to have the recited characteristics/elements. In other embodiments, the apparatus can comprise separate pieces of material that are joined together. The separate pieces can be joined via any suitable manner, including adhesives, screws, bolts, nails, rivets, solder, welds, etc. Suitably the apparatus comprises a metal or a polymer. Exemplary metals that can be used to prepare the apparatus of the present invention include, but are not limited to, aluminum, galvanized steel, stainless steel, roll-formed sheet metal, titanium, etc. Exemplary polymers include various extruded structural plastics. While in exemplary embodiments, the apparatus comprises the same material throughout, in other embodiments, separate elements of the apparatus can be prepared from different materials (e.g., different metals or different polymers).

In suitable embodiments, for a photovoltaic module having a given mass, interface 104 will have a tensile strength of between about 170 pounds to about 10,000 pounds, first support leg 106 will have a tensile strength of between about 180 pounds to about 25,000 pounds, second support leg 110 will have a tensile strength of between about 1,500 pounds to about 30,000 pounds, first support element 108 will have a tensile strength of between about 180 pounds to about 1,300 pounds, and second support element 112 will have a tensile strength of between about 400 pounds to about 25,000 pounds.

As shown in FIG. 2, apparatus 100 is suitably attached (e.g., via an adhesive) to the underside of a photovoltaic module (i.e., the glass panel of side of the module that is not oriented to receive direct sunlight). However, it should be noted that the mounting system and apparatus of the present invention can be attached to the top glass panel of a module, thereby allowing the module to be hung from a structural support, for example.

Apparatus 100 is then positioned onto structural support 204. As shown in FIG. 2, in exemplary embodiments, structural support 204 is a “C” channel, and apparatus 100 is positioned onto an edge of the channel, whereby at least first support element 108 contacts the edge of support structure 204. First support element 108 provides stability for the module and weight bearing of the module as well as any external forces. In further embodiments, structural support 204 can be an I-beam, a piece of stock material (e.g., a metal or wooden beam) or a z-bracket attached to another structure. Structural supports also include unistruts, and other metal framing materials known to a person of ordinary skill in the art, including those comprising metal, wood, plastic, carbon fiber, composites thereof, alloys thereof, and the like. Also visible in FIG. 2 is junction box 206, that provides electrical connection to the PV module 202. In exemplary embodiments, the portion of structural support 204 that interfaces with apparatus 100 of the present invention is on the order of about 0.1 inches to about 14 inches in length, for example about 2 inches to about 6 inches, or about 3 inches in length. Suitably, the portion of structural support 204 that interfaces with apparatus 100 has a thickness of about 0.01 inches to about 2.5 inches, or about 0.15 inches to about 0.38 inches, suitably about 0.25 inches in thickness.

In additional embodiments, first and/or second support elements 108/112, respectively, can optionally be attached to structural support 204. While it is not required to attach the support elements to the structural support, additional stability can be provided, for example, by attaching the support elements to the structural support via an adhesive, a nail, a screw, a bolt, or other suitable fastening mechanism.

FIG. 3 shows another embodiment of the present invention. Apparatus 300 suitably comprises a first surface 102 having an interface 104. Apparatus 300 also comprises at least a first support leg 106, suitably coupled to and extending from the first surface 102 at a position opposite interface 104. Apparatus 300 further comprises a first support element 108 coupled to and extending from first support leg 106. Suitably, first support element 108 is oriented substantially parallel to first surface 102.

As shown in FIG. 3, suitably apparatus 300 also comprises a second support leg comprising two section, 310 and 312, coupled to and extending from the first surface 102 opposite interface 104, and a second support element 112. In apparatus 300, second support leg comprising portions 310 and 312, and second support element 112 can be in the form of a “J” or “U” shape. As shown in FIG. 3, sections of support leg 310 and 312, and support element 112, are essentially one continuous structure. In this embodiment, first support element 108, second support leg comprising 310 and 312, and second support element 112 form channel 302. As in apparatus 100 shown in FIG. 1A, channel 302 is suitably designed to accept structural support 204 (for example an edge of a “C” channel.) Apparatus 300 is designed such that first 108 and second support elements 112 and second support leg comprising 310 and 312 create a deeper channel 302, as compared to channel 116 shown in FIG. 1A. Also, as described above, suitably in apparatus 300, first support element 108 is not attached to second support element 112 or second support leg portions 310 and 312 (see 118 in FIG. 3). This separation allows for easier mounting during installation, as well as increased flexibility and bending during exposure of the photovoltaic module to external stresses or loads.

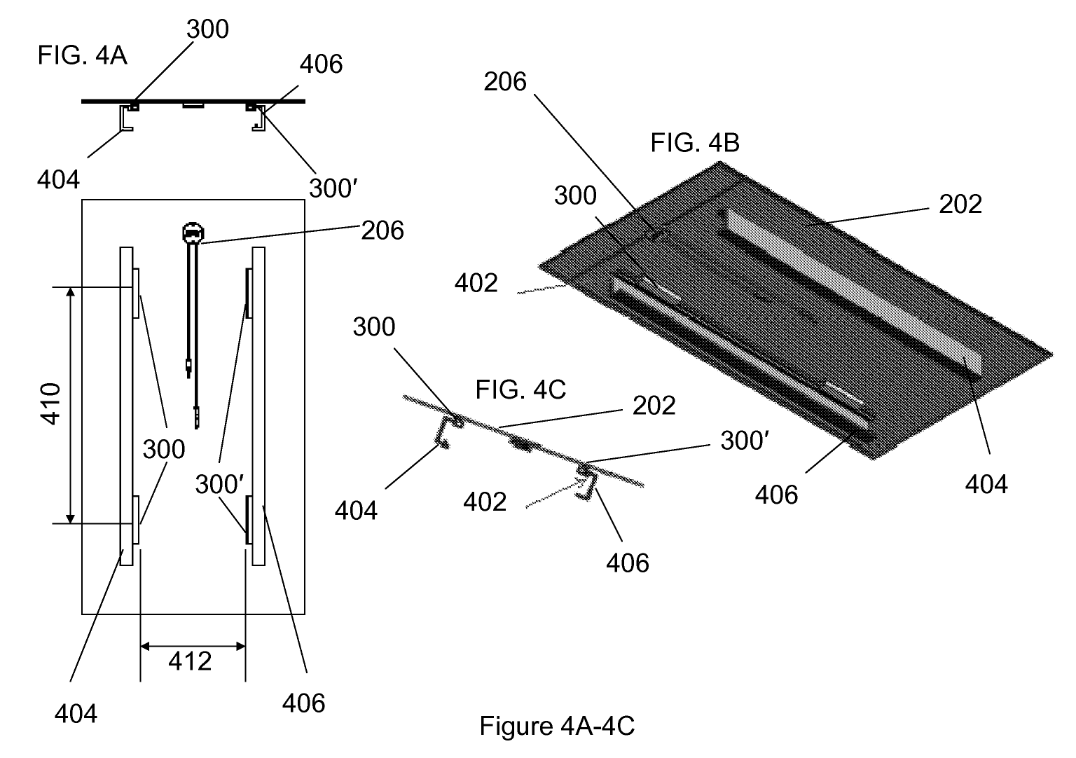

As shown in FIG. 4C, apparatus 300 with deeper channel 302 allows for apparatus 300 to be positioned onto a first structural support 404, and then a second structural support 406. For example, as in FIG. 4C, module 202 comprising at least two (suitably four or six, though other numbers of apparatuses can be used, and hence, this number is not limiting) apparatuses 300 and 300′, can be first positioned on structural support 404. For example, an edge of structural support 404 can be positioned within the channel 302 formed in apparatus 300. As channel 302 is actually deeper than the structure (e.g., edge) that it must accommodate, apparatus 300 can be slid onto the structure as it orients within the channel 302, suitably contacting support element 108. Then, the second apparatus 300′ can be positioned onto structural support 406, and module 202 slid onto support 406. Suitably, support 406 has a stop 402 that will make contact with support element 112 and add additional stability to the mounting and also prevent the module from slipping off of the structural support.

The mounting described above with reference to FIG. 4C is best envisioned when mounting a module to two different structural supports 404 and 406, in which the first structural support 404 is above the second (i.e., on a higher plane). Apparatus 300 can be first slid onto the higher structural support 404, and as channel 302 is able to accommodate more of the edge of structural support 404, it allows room so that the second apparatus 300′ can be positioned over second structural support 406 below. Then the module can be slid onto support 406 until it rests against stop 402. In such embodiments, this provides support to the module and prevents it from sliding off of the supports.

Structural supports described herein are suitably elements of an architectural structure, such as a house, an office building, a warehouse, a factory, a carport, a garage, a deck, a balcony, etc., or can be stand-alone structures such as a solar-supporting frame.

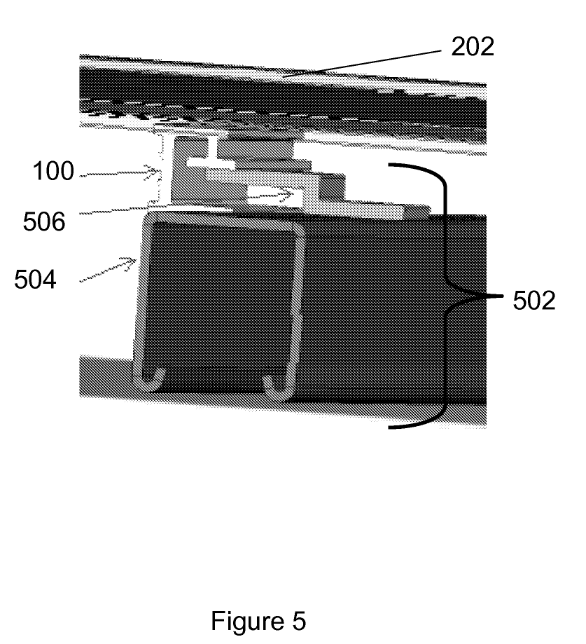

The present invention also provides supported photovoltaic modules, for example as shown in FIGS. 2, 4A-4C and 5. These figures show various, non-limiting examples of architectural elements that can be utilized as structural supports for the photovoltaic modules. For example, a “C” channel as shown in FIG. 2 (204) and FIGS. 4A-4C (404, 406) can be utilized. Alternatively, the modules can be mounted to I-beams and other stock structural supports. In other embodiments, as shown in FIG. 5, apparatus 100 can be utilized to mount module 202 to a Z-bracket 506 attached to a support member 504 (e.g., a unistrut), which make up structural support 502.

As described throughout, suitably mounting apparatuses of the present invention comprise a first surface 102 having an interface 104 attached to the photovoltaic module 202 (for example, interface 104 is attached to the module via an adhesive). The apparatus also comprises a first support leg 106 coupled to and extending from the first surface opposite the interface, and a first support element 108 coupled to and extending from the first support leg and oriented substantially parallel to the first surface.

Apparatus 100 also comprises a second support leg 110 coupled to and extending from the first surface opposite the interface, and a second support element 112 coupled to and extending from the second support leg and oriented substantially parallel to the first surface, wherein a channel 116 is formed as described herein. Suitably, at least the first support element 108 is in contact with the structural support. For example, as shown in FIG. 2, first support element 108 is in contact with the edge of the “C” channel 204, and similarly in FIGS. 4A-4C, where both first support element 108 and second support element 112 can be in contact with the edge of “C” channels 404 and 406. First support element 108 provides support to photovoltaic module 202, including load bearing and orientation support (support that helps to maintain the module in the desired position and orientation without substantially flexing, bending or shifting), while second support element 112, in addition to providing orientation support, also provides protection from lift-off of the modules due to a force applied to the underside (non-sun-exposed side) of the modules.

As illustrated in FIG. 5, in additional exemplary embodiments, only first support element 108 can be in contact with structural support, here, the top of a Z-bracket 506 attached to a member 504. Suitably, Z-bracket is attached to member 504 (e.g., a unistrut) via an adhesive or other mechanism such as a screw, bolt or nail. The weight of module 202 provides sufficient force to maintain contact between first support element 108 and the Z-bracket (or it (as well as second support element 112) can be attached via an adhesive, screw, bolt, or other suitable fastening mechanism), while second support element 112 provides support in the event that the module lifts away from structural support.

As noted herein, suitably photovoltaic module 202 is a frameless photovoltaic module, including a-Si-comprising modules. The ability to mount these frameless modules without the use of screws or other attachment pieces, simply by sliding or clipping the modules to support structures via the use of apparatus of the present invention (e.g., as shown in 100 and 300), greatly increases the ease of installation.

As described herein, the separation between first support element and second support leg/second support element allows for the apparatus to flex and bend during both installation and throughout the life of the module. Exemplary sizes of the various elements of the apparatus of the present invention are provided throughout. In addition, as noted herein, in further embodiments, the first and/or second support elements can optionally comprise a cushion pad, or a module clamp, with the channel formed by the first and/or second support elements.

In further embodiments, the present invention provides methods of mounting a photovoltaic module to a structural support. In exemplary embodiments, a photovoltaic module 202 comprising at least one mounting apparatus (e.g., 100 or 300) attached to the photovoltaic module via an interface of a first surface of the apparatus is provided. As described herein, suitably the apparatus for use in mounting methods of the present invention comprises a first support leg coupled to and extending from the first surface opposite the interface, a first support element coupled to and extending from the first support leg and oriented substantially parallel to the first surface, a second support leg coupled to and extending from the first surface opposite the interface, and a second support element coupled to and extending from the second support leg and oriented substantially parallel to the first surface, so as to form a channel as described herein. The photovoltaic module is then mounted to the structural support by contacting at least the first support element of the apparatus to the structural support.

As described throughout, in exemplary embodiments, the photovoltaic module is slid or clipped onto the structural support by sliding the apparatus attached to it onto an edge or portion of a “C” channel or other suitable structure (e.g., an I-beam, a z-bracket on a unistrut or other member).

Additional methods of mounting a photovoltaic module of the present invention include first providing a photovoltaic module (e.g., a frameless photovoltaic module). At least one mounting apparatus is then attached to the photovoltaic module via an interface of a first surface of the apparatus. As described herein, suitably the apparatus is adhered to the photovoltaic module using an adhesive. The apparatus suitably comprises, a first support leg coupled to and extending from the first surface opposite the interface, a first support element coupled to and extending from the first support leg and oriented substantially parallel to the first surface, a second support leg coupled to and extending from the first surface opposite the interface, and a second support element coupled extending from the second support leg and oriented substantially parallel to the first surface, so as to form a channel as described herein. The photovoltaic module is then mounted to the structural support by contacting at least the first support element to the structural support, for example, onto an edge or portion of a “C” channel or other suitable structure (e.g., an I-beam, a z-bracket on a unistrut or other member).

As described herein, while the modules can be mounted by utilizing a single apparatus of the present invention, suitably, the modules comprise at least two apparatuses. When utilizing two apparatuses of the present invention to mount a photovoltaic module, the apparatuses will generally be mounted at opposite sides of the module, and extend along a substantial portion of the back of the module. In further embodiments, four (or more) apparatuses can be mounted near the four corners of the module. FIGS. 4A and 4B show the mounting of module 202 onto two structural supports 404 and 406 using four apparatuses 300 and 300′ of the present invention. Only the two apparatuses mounted to structural support 404 are visible in FIG. 4B, the other two apparatuses mounted to support structure 406 are hidden from view. Stop 402 can also be seen on structural support 404.

As shown in FIGS. 4A-4C, in exemplary embodiments, the apparatuses are oriented substantially in the same plane as each other, and separated by a distance of about 15-20 inches, suitably about 16-18 inches, or about 17-18 inches, across the width of the module 412 (i.e., the shorter dimension of the module), as shown in FIG. 4A. Across the length of the module 410 (i.e., the longer dimension of the module), the apparatuses are suitably separated by a distance of about 20-40 inches. A person of ordinary skill in the art will readily recognize other orientations and spacings of the two, four, or more apparatuses on the module. For example, the apparatuses of the present invention can be rotated 90° such that the module can now be mounted in a perpendicular orientation to that shown in FIGS. 4A-4C.

The present invention also provides methods of mounting a photovoltaic module to at least two structural supports. As described herein, a photovoltaic module comprising at least one apparatus (suitably two, four, or more) of the present invention is provided. Suitably, the apparatus is adhered via an adhesive at the interface to the module. The photovoltaic module is then mounted to the structural supports by contacting the first support element of the first mounting apparatus to the first structural support. For example, as shown in FIG. 4C, first apparatus 300 is slid onto structural support 404 (e.g., an edge of a “C” channel). Then, the first support element of the second mounting apparatus 300′ is mounted to the to the second structural support 406. For example, as shown in FIG. 4C, second apparatus 300′ is slid onto structural support 406. As shown in FIG. 3 and FIG. 4A, a larger channel 302 in apparatus 300, allows for the apparatus to slide onto structural support 404 sufficiently so that apparatus 300′ is then able to slide back onto structural support 406, and rest on stop 402 to prevent the module from sliding or moving on the support structures.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

All publications, patents and patent applications mentioned in this specification are herein incorporated by reference to the same extent as if each individual publication, patent or patent application was specifically and individually indicated to be incorporated by reference.

What is claimed is:

1. A mounting apparatus for a photovoltaic module comprising:
(a) a first surface having an interface for attachment to the photovoltaic module;
(b) a first support leg coupled to and extending from the first surface opposite the interface;
(c) a first support element coupled to and extending from the first support leg and oriented substantially parallel to the first surface;
(d) a second support leg coupled to and extending from the first surface opposite the interface; and
(e) a second support element coupled to and extending from the second support leg and oriented substantially parallel to the first surface,
wherein the first support element and the second support element form a channel.

2. The mounting apparatus of claim 1, wherein the photovoltaic module is a frameless photovoltaic module.

3. The mounting apparatus of claim 1, wherein the interface comprises one or more spacers.

4. The mounting apparatus of claim 1, wherein the interface comprises an adhesive.

5. The mounting apparatus of claim 1, wherein the second support leg extends beyond the first support leg.

6. The mounting apparatus of claim 1, wherein
the first support leg is formed integral with the first surface;
the first support element is formed integral with the first support leg;
the second support leg is formed integral with the first surface; and
the second support element is formed integral with the second support leg.

7. The mounting apparatus of claim 1, wherein the first support element is not attached to the second support element or the second support leg.

8. The mounting apparatus of claim 1, wherein the first support element, the second support leg and the second support element form a channel.

9. The mounting apparatus of claim 1, wherein the interface of the first surface is between about 0.1 to about 6 inches by about 0.7 to about 14 inches in dimension.

10. The mounting apparatus of claim 1, wherein the first leg is between about 0.01 to about 2 inches in length.

11. The mounting apparatus of claim 1, wherein the second leg is between about 0.02 to about 12 inches in length.

12. The mounting apparatus of claim 1, wherein the first support element is between about 0.1 to about 4 inches by about 0.7 to about 14 inches in dimension.

13. The mounting apparatus of claim 1, wherein the second support element is between about 0.1 to about 6 inches by about 0.7 to about 14 inches in dimension.

14. The mounting apparatus of claim 1, wherein the first and/or second support elements further comprise a cushion pad.

15. The mounting apparatus of claim 1, further comprising a module shim clip within the channel.

16. The mounting apparatus of claim 1, wherein the apparatus comprises aluminum or steel or a polymer.

17. A supported photovoltaic module, comprising:
(a) a structural support; and
(b) a photovoltaic module mounted to said structural support via a mounting apparatus comprising
(i) a first surface having an interface attached to the photovoltaic module;
(ii) a first support leg coupled to and extending from the first surface opposite the interface;
(iii) a first support element coupled to and extending from the first support leg and oriented substantially parallel to the first surface;
(iv) a second support leg coupled to and extending from the first surface opposite the interface; and
(v) a second support element coupled to and extending from the second support leg and oriented substantially parallel to the first surface,
wherein the first support element and the second support element form a channel, and wherein at least the first support element is in contact with the structural support.

18. A method of mounting a photovoltaic module to a structural support, comprising:
(a) providing a photovoltaic module;
(b) attaching at least one mounting apparatus to the photovoltaic module via an interface of a first surface of the apparatus, the apparatus comprising
(i) a first support leg extending from the first surface opposite the interface;
(ii) a first support element extending from the first support leg and oriented substantially parallel to the first surface;
(iii) a second support leg extending from the first surface opposite the interface; and
(iv) a second support element extending from the second support leg and oriented substantially parallel to the first surface, wherein the first support element and the second support element form a channel; and
(c) mounting the photovoltaic module to the structural support by contacting at least the first support element to the structural support.

19. The method of claim 18, wherein the providing comprises providing a frameless photovoltaic module.

20. The method of claim 18, wherein the attaching comprises adhering the mounting apparatus to the photovoltaic module via an adhesive on the interface of the first surface of the apparatus.
